(19) United States
(12) Patent Application Publication
(10) Pub. No.: US 2025/0292779 A1
(43) Pub. Date: Sep. 18, 2025

(54) SOURCE TRACING OF AUDIO DEEPFAKE SYSTEMS

(71) Applicant: Pindrop Security, Inc., Atlanta, GA (US)

(72) Inventors: Nicholas KLEIN, Atlanta, GA (US); Hemlata TAK, Atlanta, GA (US); Ricardo CASAL, Atlanta, GA (US); Tianxiang CHEN, Atlanta, GA (US); Elie KHOURY, Atlanta, GA (US)

(73) Assignee: Pindrop Security, Inc., Atlanta, GA (US)

(21) Appl. No.: 19/076,960

(22) Filed: Mar. 11, 2025

Related U.S. Application Data
(60) Provisional application No. 63/564,433, filed on Mar. 12, 2024.
(60) Provisional application No. 63/760,943, filed on Feb. 20, 2025.

(51) Int. Cl. G10L 17/26; G06F 9/451; G10L 17/04

(52) U.S. Cl. CPC G10L 17/26; G06F 9/451; G10L 17/04

(57) ABSTRACT

Disclosed are systems and methods including software processes executed by a server that implement a machine-learning architecture for audio source tracing for deepfake detection. The computer extracts a feature vector representing features of the input audio signal. The machine-learning architecture includes one or more embedding extractors for extracting one or more feature vectors from the input audio signal. An attribute detector ingests an embedding and scoring layers generate a source-indicating attribute score. A source tracer includes a multi-class classifier to generate a signal source score using the attribute scores and generates a signal source class.

### CROSS-REFERENCE TO RELATED APPLICATIONS

This application claims priority to U.S. Provisional Application No. 63/760,943, filed Feb. 20, 2025, and U.S. Provisional Application No. 63/564,433, filed Mar. 12, 2024, each of which is incorporated by reference in its entirety.

### TECHNICAL FIELD

The present disclosure relates generally to the field of audio deepfake detection and source tracing. More specifically, embodiments relate to machine-learning architectures designed to identify and trace the origins of manipulated audio signals.

### BACKGROUND

Conventional deepfake technologies face significant challenges in accurately detecting and tracing the origins of manipulated audio. A major shortcoming is the reliance on closed-set scenarios, where the system is trained and tested on a fixed set of known deepfake sources. This approach limits the system's ability to generalize to new, unseen deepfake sources, resulting in reduced effectiveness in real-world applications where new deepfake technologies are constantly emerging.

Another technological shortcoming is the inability of existing systems to handle out-of-distribution (OOD) data effectively. Deep neural network models often struggle to recognize data that deviates from the training set, leading to high false-positive rates when encountering OOD data. This limitation undermines the reliability of deepfake detection systems, as they may fail to identify novel deepfake sources or mistakenly classify genuine audio as fake.

Furthermore, conventional deepfake detection systems often lack robustness in open-set scenarios. These systems are typically designed to perform well in controlled environments with a limited number of known deepfake sources. However, in open-set scenarios, where the number of potential deepfake sources is vast and constantly evolving, these systems exhibit poor performance. This shortcoming is particularly problematic given the rapid proliferation of new deepfake technologies.

Another shortcoming is that existing deepfake detection methods frequently suffer from overconfidence in their predictions. This overconfidence can lead to incorrect classifications, as the models may assign high confidence scores to OOD data or misclassify genuine audio as deepfake. The lack of a reliable mechanism to gauge the uncertainty of predictions further exacerbates this issue, making it challenging to trust the outputs of conventional deepfake detection systems.

### SUMMARY

Disclosed herein are systems and methods capable of addressing the above-described shortcomings and may also provide any number of additional or alternative benefits and advantages. Embodiments described herein implement a machine-learning architecture designed for deepfake detection and source tracing. The machine-learning architecture employs a multi-class classification model to identify specific source-indicating attributes of synthetic audio signals, such as the acoustic model, vocoder, and input type. The machine-learning architecture includes separate neural network models for each audio attribute detector, optimizing the classification process and providing a comprehensive solution for identifying and tracing synthetic audio sources.

Embodiments may include a computer-implemented method for detecting fraudulent calls and source detection using machine-learning. The method may include extracting, by a computer, a feature vector embedding representing a set of spoofing features extracted from an input audio signal; generating, by the computer, a plurality of attribute scores using a plurality of attribute detectors of a machine-learning architecture based upon the feature vector embedding, each attribute detector includes a machine-learning model trained to generate an attribute score indicating a likelihood of a source-indicating attribute that generated the audio signal; generating, by the computer, a signal source score based upon the plurality of attribute scores, the signal source score indicating a probability of an audio source technology that generated the audio signal; identifying, by the computer, the audio source technology based upon the signal source score according to one or more class thresholds using a multi-class classifier; and generating, by the computer, a notification for display at a user interface indicating the audio source technology that originated the audio signal.

The source-indicating attribute may include at least one of an input type, an acoustic model, or a vocoder.

The method may further include training, by the computer, a first embedding extractor to extract the feature vector embedding having the spoofing features using a plurality of training audio signals including the audio signal and corresponding training labels.

The method may further include training, by the computer, a plurality of embedding extractors for extracting a plurality of feature vector embeddings corresponding to the plurality of attribute detectors, including the first embedding extractor corresponding to a first attribute detector, and a second embedding extractor corresponding to a second attribute detector.

The method may further include generating, by the computer, a first attribute score for a first source-indicating attribute using a first attribute detector based upon the feature vector embedding.

The method may further include extracting, by the computer, a second feature vector embedding representing a second set of spoofing features extracted from the audio signal; and generating, by the computer, a second attribute score for a second source-indicating attribute based upon the second feature vector embedding using a second attribute detector.

The method may further include generating, by the computer, a loss for the signal source score using a loss function, the loss indicating a distance between the signal source and an expected signal source score indicated by a training label associated with the input audio signal; and updating, by the computer, one or more parameters of the multi-class classifier model based upon the loss.

The method may further include updating, by the computer, one or more parameters of one or more embedding extractors model based upon the loss.

The method may further include updating, by the computer, one or more parameters of one or more source attribute detectors based upon the loss.

Embodiments may include a system for detecting fraudulent calls and source detection using machine-learning. The system may include a computer having at least one processor. The computer may be configured to: extract a feature vector embedding representing a set of spoofing features extracted from the audio signal; generate a plurality of attribute scores using a plurality of attribute detectors of a machine-learning architecture based upon the feature vector embedding, each attribute detector includes a machine-learning model trained to generate an attribute score indicating a likelihood of a source-indicating attribute that generated the audio signal; generate a signal source score based upon the plurality of attribute scores, the signal source score indicating a probability of an audio source technology that generated the audio signal; identify the audio source technology based upon the signal source score according to one or more class thresholds using a multi-class classifier; and generate a notification for display at a user interface indicating the audio source technology that originated the audio signal.

The source-indicating attribute may include at least one of an input type, an acoustic model, or a vocoder.

The computer may be further configured to train a first embedding extractor to extract the feature vector embedding having the spoofing features using a plurality of training audio signals including the audio signal and corresponding training labels.

The computer may be further configured to train a plurality of embedding extractors for extracting a plurality of feature vector embeddings corresponding to the plurality of attribute detectors, including the first embedding extractor corresponding to a first attribute detector, and a second embedding extractor corresponding to a second attribute detector.

The computer may be further configured to generate a first attribute score for a first source-indicating attribute using a first attribute detector based upon the feature vector embedding.

The computer may be further configured to extract a second feature vector embedding representing a second set of spoofing features extracted from the audio signal; and generate a second attribute score for a second source-indicating attribute based upon the second feature vector embedding using a second attribute detector.

The computer may be further configured to generate a loss for the signal source score using a loss function, the loss indicating a distance between the signal source and an expected signal source score indicated by a training label associated with the input audio signal.

The computer may be further configured to update one or more parameters of the multi-class classifier model based upon the loss.

The computer may be further configured to update one or more parameters of one or more embedding extractors model based upon the loss.

The computer may be further configured to update one or more parameters of one or more source attribute detectors based upon the loss.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows components of an example system for handling and analyzing calls from callers, according to an embodiment.

FIG. 2 shows data flow amongst components of a system when training a machine-learning architecture executed by a computer (e.g., analytics server) for deepfake detection and audio source-tracing, according to an embodiment.

FIG. 3 shows data flow amongst components of a system when training a machine-learning architecture executed by a computer (e.g., analytics server) for deepfake detection and audio source tracing, according to an embodiment.

FIG. 4 is a flowchart showing operations of a computer-implemented method for detecting fraudulent calls and source detection using a machine-learning architecture, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Conventional anti-fraud systems may detect deepfakes in manipulated or synthetic audio signals. A problem is that conventional systems could not determine a source of fraudulent audio signal. The previous approaches could detect deepfakes, but the prior approaches could not identify the source of audio signal containing the deepfakes. The conventional anti-fraud systems were typically limited to binary classification. Prior methods focused on binary classification (e.g., genuine or fraudulent) and did not extend to identifying specific attributes or sources of the audio.

Existing technologies for detecting deepfakes and synthetic audio have several notable shortcomings. Traditional approaches primarily focus on binary classification, determining whether an audio sample is genuine or synthetic. While these methods can identify the presence of deepfakes, these existing approaches fall short in detecting, for example, the specific source of the deepfake audio signal or the underlying technologies used to generate the synthetic audio. This limitation is critical, as understanding the source can provide valuable insights into the nature of the threat and enable more effective countermeasures. Additionally, current technologies often struggle with open-set scenarios in which new or previously unseen synthetic audio-generating models are introduced. The existing anti-fraud models are typically trained on a fixed set of known classes and lack the capability to recognize and adapt to new, unknown sources, leading to potential misclassifications and reduced reliability. Furthermore, the existing methods do not adequately address the need for detailed attribute classification, such as identifying the specific acoustic model or vocoder used in the synthesis process. This granularity is essential for comprehensive source tracing and forensic analysis. A problem, for example, is that existing approaches did not identify or consider source-indicating attributes needed to determine audio source. The conventional systems did not extract, consider, or generate information about, for example, the acoustic model, vocoder, or input type used in generating the deepfake audio signal.

Embodiments described herein implement a computer-implemented machine-learning architecture for deepfake detection and source tracing. The machine-learning architecture detect and classify synthetic audio sources. Unlike traditional binary classifiers, the machine-learning architecture employs a multi-class classification machine-learning model that can identify specific source-indicating attributes of the audio signals, such as the acoustic model, vocoder, and input type. This granularity allows for precise source-tracing, enabling the identification of, for example, the types of technology used to generate the synthetic audio signal. Additionally, the machine-learning architecture incorporates advanced loss functions, such as cosine space loss, which enhance the machine-learning architecture's ability to distinguish between known and unknown sources. In this way, the machine-learning architecture has an open-set capability that enables the machine-learning architecture to recognize and adapt to new, previously unseen models for generating synthetic audio signals. By leveraging embeddings and refined feature representations, the machine-learning architecture provides detailed source-indicating attribute classification and source signal classification, addressing the limitations of existing methods and offering a comprehensive solution for synthetic audio detection and source tracing.

In some embodiments, a computer implements a machine-learning architecture that uses standalone, end-to-end neural networks having end-to-end learning for attribute classification and source detection. The computer trains separate neural network models for each attribute of an input audio signal, allowing the overall machine-learning architecture to learn and optimize parameters holistically for an overall operation of detecting and tracing audio deepfakes. Each network is trained independently to handle specific attributes of the audio signal (e.g., input type, acoustic model, vocoder) based on temporal and spectral characteristics. This approach simplifies the training process and allows each respective attribute neural network to focus on learning the most relevant features for an assigned attribute. The overall goal is to accurately classify the audio signal as genuine or deepfake by leveraging the combined outputs of these standalone networks.

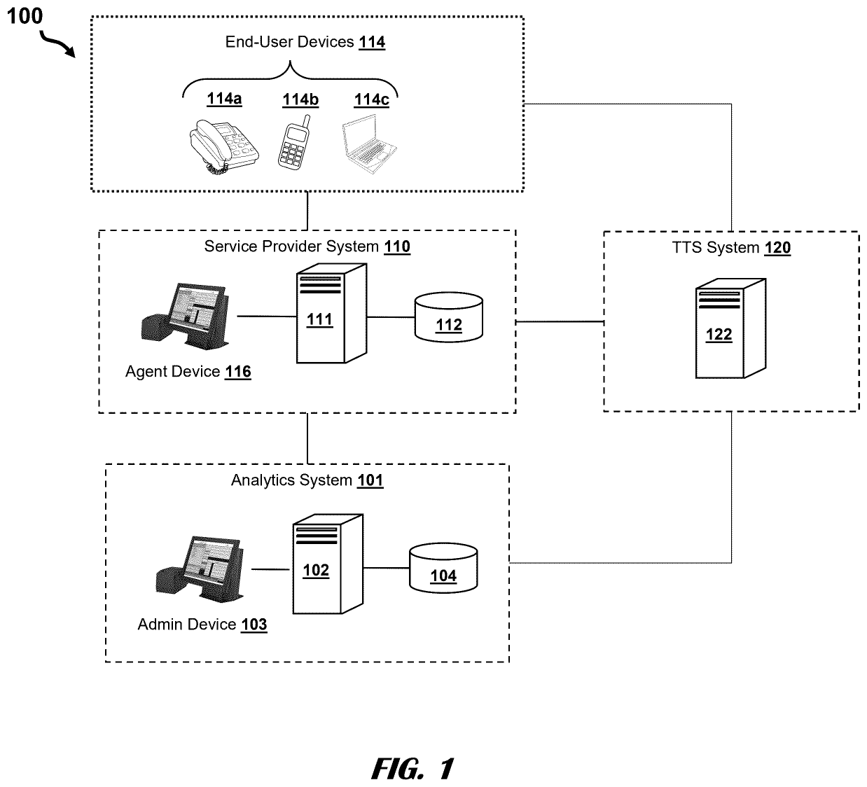

FIG. 1 shows components of an example system 100 for handling and analyzing calls from callers, according to an embodiment. The system 100 comprises an analytics system 101, service provider systems 110 of various types of enterprises (e.g., companies, government entities, universities), a text-to-speech (TTS) system 120, and one or more end-user devices 114a-114c, including landline phones 114a, mobile phones 114b, and computing devices 114c (generally referred to as the end-user devices 114 or the end-user device 114). The analytics system 101 includes analytics servers 102, analytics databases 104, and admin devices 103. The service provider system 110 includes provider servers 111, provider databases 112, and agent devices 116. The TTS system 120 includes TTS servers 122 and TTS databases 124.

Embodiments may comprise additional or alternative components or omit certain components from what is shown in FIG. 1, and still fall within the scope of this disclosure. It may be common, for example, for the system 100 to include multiple provider systems 110 or multiple TTS systems 120, or for the analytics system 101 to have multiple analytics servers 102. It should also be appreciated that embodiments may include or otherwise implement any number of devices capable of performing the various features and tasks described herein. For example, the FIG. 1 shows the analytics server 102 as a distinct computing device from the analytics database 104, though in some embodiments, the analytics database 104 may be integrated into the analytics server 102.

The one or more networks of the system 100 includes various hardware and software components of one or more public or private networks that interconnect the various components of the system 100 and host or conduct audio and voice communications originated at the end-user devices 114. Non-limiting examples of such networks may include: Local Area Network (LAN), Wireless Local Area Network (WLAN), Metropolitan Area Network (MAN), Wide Area Network (WAN), and the Internet. The communication over the network 104 may be performed in accordance with various communication protocols, such as Transmission Control Protocol and Internet Protocol (TCP/IP), User Datagram Protocol (UDP), and IEEE communication protocols. Likewise, the end-user devices 114 may communicate with callees (e.g., provider systems 110) via telephony and telecommunications protocols, hardware, and software of the networks, capable of hosting, transporting, and exchanging audio data associated with telephony-based calls. Non-limiting examples of telecommunications hardware of the networks 104 may include switches and trunks, among other additional or alternative hardware used for hosting, routing, or managing telephone calls, circuits, and signaling. Non-limiting examples of software and protocols of the networks for telecommunications may include SS7, SIGTRAN, SCTP, ISDN, and DNIS among other additional or alternative software and protocols used for hosting, routing, or managing telephone calls, circuits, and signaling. Various different entities manage or organize the components of the telecommunications systems of the networks 104, such as carriers, networks, and exchanges, among others.

The end-user devices 114 may be any communications or computing device the caller operates to place the telephone call to the call destination (e.g., the service provider system 110). The end-user device 114 may comprise, or be coupled to, a microphone. Non-limiting examples of end-user devices 114 may include landline phones 114a and mobile phones 114b. It should be appreciated that the end-user device 114 is not limited to telecommunications-oriented devices (e.g., telephones). As an example, a calling end-user device 114 may include an electronic device comprising a processor and/or software, such as a computing device 114c or Internet of Things (IoT) device, configured to implement voice-over-IP (VoIP) telecommunications. As another example, the caller computing device 114c may be an electronic IoT device (e.g., voice assistant device, “smart device”) comprising a processor and/or software capable of utilizing telecommunications features of a paired or otherwise networked device, such as a mobile phone 114b.

The system 100 may include one or more network system infrastructures 101, 110, 120, including the analytics system 101, the provider system 110, and the TTS system 120. The network system infrastructures 101, 110, 120 include physically and/or logically related collections of software and electronic devices managed or operated by various enterprise organizations. The devices of each network system infrastructure 101, 110, 120 are configured to provide the intended services of the particular enterprise organizations.

The analytics system 101 is operated by an analytics service that provides various call management, security, authentication (e.g., speaker verification), and analysis services to customer organizations (e.g., corporate call centers, government entities). Components of the call analytics system 101, such as the analytics server 102, execute various processes using audio data in order to provide various call analytics services to the organizations that are customers of the call analytics service. In operation, a caller uses a caller end-user device 114 to originate a call to the service provider system 110. The microphone of the end-user device 114 observes the caller's speech and generates the audio data represented by the observed audio signal.

Optionally, the system 100 includes a TTS system 120. The TTS system 120 includes a TTS server 122 that executes software programming for generating synthetic speech signals as speech audio signals according to instructions or text inputs as received from an end-user device 114. The TTS server 122 or other device of the system 100 further executes software programming (e.g., encoder) for encoding an audio signal having a speech audio signal (e.g., synthetic speech, genuine speech audio). The TTS server 122 or other device of the system 100 transmits or otherwise provides the call data, containing the audio signal data and metadata information to the analytics server 102, the provider server 111, or other type of destination device. In some cases, the end-user devices 114 generate the synthetic speech signals using locally installed and executed TTS software.

The end-user device 114 initiates and originates a call to the service provider system 110 and transmits the call data to the service provider system 110. The end-user device 114 and components of telephony networks and carrier systems (e.g., switches, trunks) or computing communications networks to perform telephony or networked-communications operations for handling and routing the call data of the new call, including, for example, interpretation, processing, transmission, and routing the call data from the end-user device 114 to the service provider system 110 or the TTS system 120. In some cases, the call data or audio signal data captured by a microphone of the end-user device 114 or generated by the TTS system 120. The service provider system 110 or the TTS system 120 then transmits the call data to the analytics system 101 to perform various analytics and downstream audio processing operations. It should be appreciated that analytics servers 102, analytics databases 104, and admin devices 103 may each include or be hosted on any number of computing devices comprising a processor and software and capable of performing various processes described herein.

The service provider system 110 is operated by an enterprise organization (e.g., corporation, government entity) that is a customer of the call analytics system 101. In operation, the service provider system 110 receives the audio data and/or the observed audio signal associated with the telephone call from the end-user device 114. The audio data may be received and forwarded by one or more devices of the service provider system 110 to the call analytics system 101 via one or more networks. For instance, the customer may be a bank that operates the service provider system 110 to handle calls from consumers regarding accounts and product offerings. Being a customer of the call analytics service, the bank's service provider system 110 (e.g., bank's call center) forwards the audio data associated with the inbound calls from consumers to the call analytics system 101, which in turn performs various processes using the audio data, such as analyzing the audio data to detect synthetic speech used to impersonate a customer of the bank, among other voice or audio processing services for risk assessment or speaker identification. It should be appreciated that service provider servers 111, provider databases 112 and agent devices 116 may each include or be hosted on any number of computing devices comprising a processor and software and capable of performing various processes described herein.

Turning to the analytics system 101, the analytics system 101 includes an analytics server 102 and an analytics database 104. The analytics database 104 (and/or the call center database 112 of the service provider system 110) may contain any number of corpora of training audio signals that are accessible to the analytics server 102 via one or more networks. The analytics database 104 may include the training audio signals and training labels corresponding to the training audio signals. The training labels may indicate expected outputs for the training audio signals, such as an expected signal source score or expected signal source, expected feature vector embeddings, and expected source attribute scores or expected source attribute classes. In some embodiments, the analytics server 102 employs supervised training to train the machine-learning models of the machine-learning architecture, where the analytics database 104 includes the training labels associated with the training audio signals that indicate, for example, the characteristics or features of the training audio signals. An administrator may configure the analytics server 102 to select the training audio signals having certain characteristics or features.

The analytics server 102 of the call analytics system 101 may be any computing device comprising one or more processors and software, and capable of performing the various processes and tasks described herein. The analytics server 102 may host or be in communication with the analytics database 104 and may receive and process the audio data from the one or more service provider systems 110. Although FIG. 1 shows only a single analytics server 102, it should be appreciated that, in some embodiments, the analytics server 102 may include any number of computing devices. In some cases, the computing devices of the analytics server 102 may perform all or sub-parts of the processes and benefits of the analytics server 102. The analytics server 102 may comprise computing devices operating in a distributed or cloud computing configuration and/or in a virtual machine configuration. It should also be appreciated that, in some embodiments, functions of the analytics server 102 may be partly or entirely performed by the computing devices of the service provider system 110 (e.g., the service provider server 111).

The analytics server 102 includes software programming of one or more machine-learning models of a machine-learning architecture, programmed and trained to perform operations for detecting instances of deepfakes occurring audio signal data and identifying a source of the audio signal data. The machine-learning architecture may include task-specific sub-architectures for identifying source-indicating attributes within the features of input audio signals. The task-specific sub-architectures may include machine-learning models for extracting feature vector embeddings (embedding extractors) using features indicative of spoofing or deepfakes (referred to as “fakeprints”), identifying spoofed audio signals (deepfake detectors), identifying certain source-indicating attributes (attribute detectors), and identifying a particular source of an audio signal (signal tracer multi-class classifier).

The machine-learning architecture may include an embedding extractor trained for extracting features indicative of spoofing from audio signal data in order to extract a feature vector embedding representing the spoofing features (or “fakeprint”) of the audio signal data. Layers of a neural network within the machine-learning architecture are trained to operate as embedding extractors that generate the fakeprint feature vectors representing certain types of embeddings using features indicative of fraudulent audio signals. As an example, the fakeprint embedding extractor may be a neural network architecture (e.g., CNN, ResNet, SyncNet) that processes a first set of features extracted from certain segments of the input audio signals, where the fakeprint extractor comprises any number of convolutional layers, statistics layers, and fully-connected layers and trained according to one or more types of loss functions.

Fakeprints are feature vector embeddings representing the characteristics of spoofing from audio signal data. These fakeprints are extracted by an embedding extractor, which is programmed and trained to identify features of the spoofing. The extractor can use various machine-learning models, such as convolutional neural networks (CNNs) or recurrent neural networks (RNNs), such as long short-term memory (LSTM) networks. In the case of CNNs, the input audio data is converted into a spectrogram, which shows the frequency components of the audio signal over time. The spectrogram is processed through multiple layers of convolutional and pooling operations in the CNN, capturing hierarchical features from basic edges to complex patterns. The final layer produces the fakeprint, a compact and informative feature vector embedding. Alternatively, LSTM networks segment the audio data into short frames and process them sequentially, maintaining a hidden state that captures temporal dependencies. The sequence of hidden states is aggregated to form the fakeprint, encapsulating both local and global audio characteristics.

The machine-learning architecture may further include source-attribute detectors having scoring layers and a classifier trained for identifying a source-indicating attribute in the audio signal data by generating a source-indicating attribute scores using the extracted fakeprint and determining whether the source attribute score satisfies a source attribute detection threshold score. The analytics server 102 feeds the extracted feature vector embeddings from the embedding extractors into one or more attribute detectors. In some implementations, a first attribute detector is programmed and trained for “input type” detection as a first source-indicating attribute. The first attribute detector identifies whether the input audio was generated by text, synthetic speech, or genuine speech audio. A second attribute detector is programmed and trained for acoustic model identification as a second source-indicating attribute. The second attribute detector identifies or classifies the acoustic model used for generating the input audio signal. A third attribute detector is programmed and trained for vocoder classification as a third source-indicating attribute. The third attribute detector identifies or classifies the vocoder used for generating audio signal.

The attribute detectors include scoring layers and/or classifier layers that are programmed and trained to generate the source-indicating attribute scores. The scoring layer of the particular attribute detector maps the refined embeddings to the respective classes for the source-indicating attribute being determined (e.g., acoustic model, vocoder, input type). The scoring layers of the attribute detector include a softmax activation function that converts the raw source-attribute scores into probabilities for each class. The output values of each attribute detector includes the source-indicating attribute score indicating a likelihood of each class for the given source-indicating attribute. In some cases, the source attribute outputs may include, for example, the source attribute score generated by fully-connect layers (or other scoring layers) of the attribute detectors. In some cases, the source attribute output of an attribute detector may include, for example, a predicted source attribute generated by a classifier of the attribute detector.

The attribute detectors may feed the source attribute outputs (e.g., source attribute score, source-attribute class) to a source tracer that includes a multi-class classifier. The multi-class classifier is programmed and trained to identify or classify a particular originating source of the input audio signal using the source attribute outputs from the respective attribute detectors. For each attribute detector, the class with the highest probability is selected as the predicted source-indicating attribute. The machine-learning architecture algorithmically combines or concatenates the source-indicated attribute scores and feeds the source-indicating attribute score to the multi-class classifier, which is programmed and trained to generate a signal source score to predict a particular audio source of the input audio signal.

In some embodiments, the machine-learning architecture may further include a deepfake detector that includes layers of one or more machine-learning models programmed and trained for determining whether an input audio signal is genuine or fraudulent, or otherwise detecting instances of fraud (e.g., deepfakes, spoofing) in the input audio signal. The deepfake detectors include scoring layers and/or classifier layers that are programmed and trained to generate the risk score and fraud determination using the corresponding fakeprints. The scoring layers generate the risk scores based upon similarities between the fakeprint and previously trained or generated fraud-detection clusters or centroids. The machine-learning architecture feeds the fakeprint to the fraud classifier or scoring layers to perform various scoring operations. The scoring layers and/or the fraud classifier perform a distance scoring operation that determines the distance (e.g., similarities, differences) between the fakeprint and a centroid or fakeprint feature vector previously generated as fraud-detection cluster using training fakeprints extracted for the training audio signals. Each risk score indicates the likelihood that the input audio signal is genuine or fraudulent, where the particular segments include deepfake or spoofed attributes. The risk score may be a value generated by the scoring layers and/or fraud classifier based on one or more scoring operations (e.g., distance scoring). For instance, the scoring layers or classifier of the deepfake detector determines whether the distance score or other outputted values satisfy threshold values.

Example embodiments of the deepfake detection engines may be found in U.S. application Ser. No. 18/646,228, U.S. Pat. No. 11,862,177, each of which is incorporated by reference in its entirety.

During training, the machine-learning architecture receives training audio signals 203a and training label data. Each embedding extractor extracts a respective fakeprint embedding. Each attribute detector uses a corresponding fakeprint embedding to generate a predicted source attribute output, which may include a predicted source attribute score or a predicted source attribute class. The multi-class classifier then generates a predicted signal source score or predicted audio data source. The machine-learning architecture may execute one or more loss functions that generate a level of error or loss for each attribute detector. The loss function may compute the loss value for each particular attribute detectors based upon a distance or comparison between one or more predicted source attribute outputs (e.g., predicted source attribute score, predicted source attribute class) as compared against one or more expected source attribute outputs (e.g., expected source attribute score, expected source attribute class) as indicated by the training label associated with the particular training audio signal in a training dataset. The loss layers or other executable operations of the machine-learning architecture employ backpropagation to adjust parameters or weights of the machine-learning models of the machine-learning architecture, such as the embedding extractors and/or attribute detectors.

At deployment time, the analytics server 102 receives an inbound audio signal from the end-user device 114 via the service provider system 110 and executes the machine-learning architecture. The analytics server 102 feeds the inbound audio signal to the input layers to perform various preprocessing operations on the inbound audio signal. The input layers feed the inbound audio signals to the embedding extractors to extract one or more feature vector embeddings. Each attribute detector ingests a feature vector embedding and generates the source-indicating attribute score indicating the likely source-indicating attribute class. The machine-learning architecture feeds the source-indicating attribute scores to the multi-class classifier, which generates a signal source score indicating the likely signal source of the inbound audio signals. The multi-class classifier may generate the source signal score by algorithmically combining the source-attribute scores to generate or compute the signal source score. The multi-class classifier may compare the signal source score against the thresholds values to identify or classify the signal source class or signal source identifier, which represents the likely source of the signal.

The analytics server 102 may generate and transmit deepfake signal information related to a detected deepfake signal and audio signal source for display at a user interface of a client computing device (e.g., admin devices 103, agent devices 116, end-user device 114). The signal information may indicate, for example, a likely signal source that originated the inbound audio signals, among other types of signal information.

The call center server 111 of a call center system 110 executes software processes for managing a call queue and/or routing calls made to the call center system 110 through the various channels, where the processes may include, for example, routing calls to the appropriate call center agent devices 116 based on the inbound caller's comments, instructions, IVR inputs, or other inputs submitted during the inbound call. The call center server 111 can capture, query, or generate various types of information about the call, the caller, and/or the caller device 114 and forward the information to the agent device 116, where a graphical user interface (GUI) of the agent device 116 displays the information to the call center agent. The call center server 111 also transmits the information about the inbound call to the call analytics system 101 to preform various analytics processes on the inbound audio signal and any other audio data. The call center server 111 may transmit the information and the audio data based upon preconfigured triggering conditions (e.g., receiving the inbound phone call), instructions or queries received from another device of the system 100 (e.g., agent device 116, admin device 103, analytics server 102), or as part of a batch transmitted at a regular interval or predetermined time.

The admin device 103 of the call analytics system 101 is a computing device allowing personnel of the call analytics system 101 to perform various administrative tasks or user-prompted analytics operations. The admin device 103 may be any computing device comprising a processor and software, and capable of performing the various tasks and processes described herein. Non-limiting examples of the admin device 103 may include a server, personal computer, laptop computer, tablet computer, or the like. In operation, the user employs the admin device 103 to configure the operations of the various components of the call analytics system 101 or call center system 110 and to issue queries and instructions to such components.

The agent device 116 of the call center system 110 may allow agents or other users of the call center system 110 to configure operations of devices of the call center system 110. For calls made to the call center system 110, the agent device 116 receives and displays some or all of the relevant information associated with the call routed from the call center server 111. The agent device 116 includes a user interface that presents the information determined by the analytics server 102 about the caller or end-user device, including one or more scores or determinations, such as a message or alert notification indicating the call is likely fraud. The admin device allows the call center to agent to manage the agent's ongoing call status or queue, which includes allowing the agent to reject calls or route calls or otherwise perform mitigation actions when the analytics server 102 determines and indicates that the call is likely fraud.

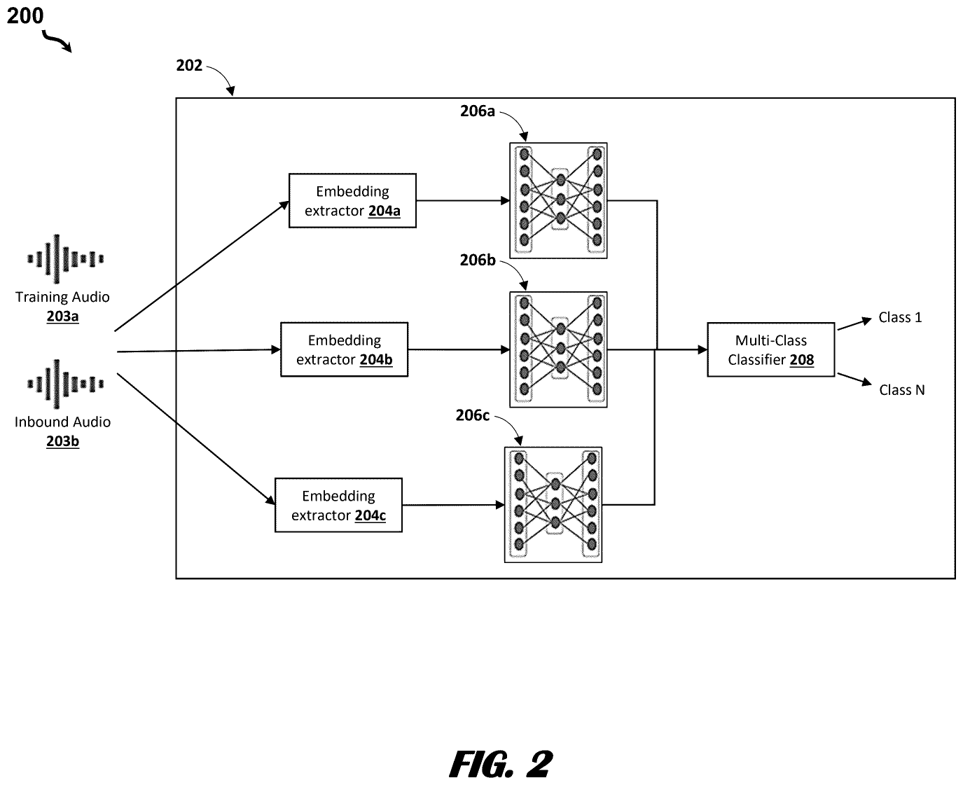

FIG. 2 shows data flow amongst components of a system 200 when training a machine-learning architecture 202 executed by a computer (e.g., analytics server 102) for deepfake detection and audio source-tracing, according to an embodiment. The system 200 includes a server (e.g., analytics server 102) executing software programming and routines that implement a machine-learning architecture 202 for source tracing and deepfake detection. In the example system 200, the server executes the software programming of machine-learning layers of machine-learning models within the machine-learning architecture 202 for detecting deepfakes and source tracing for input audio signals 303a-303b (generally referred to as input audio signals 203) at various operational phases (e.g., training, deployment). For instance, at a training phase, the server executes the machine-learning architecture 202 using training audio signals 203a. At a deployment phase, the server executes the machine-learning architecture 202 using inbound audio signals 203b.

The server includes and executes software programming of the various layers and functions of the machine-learning architecture 202 for processing one or more input audio signals 203, detecting deepfakes that may occur in an input audio signal 203, and identifying sources of the input audio data 203. The machine-learning architecture 202 includes embedding extractors 304a-304c (generally referred to as embedding extractors 204) and attribute detectors 306a-306c (generally referred to as attribute detectors 206). Each embedding extractor 204 functions as a frontend for ingesting the training audio signals 203a and extracting feature vector embeddings (sometimes referred to as “fakeprints”) having features extracted from the input audio signal 203 that are indicative of deepfakes or spoofing, among other potential functions. Each attribute detector 206 functions as a backend that identifies or classifies certain source-indicating attributes, such as input type, acoustic model, and vocoder.

The server trains the machine-learning architecture 202 for audio source tracing using training audio signals 203a. In the example embodiment of FIG. 2, the server separately trains each task-specific sub-architecture for multi-class attribute classification using the input audio signal 203, which the server obtains from one or more corpora of a database (e.g., analytics database 104, provider database 112) or other data source containing input audio signal 203.

The training audio signals 203a used for training the components of the machine-learning architecture 202 for detecting deepfake attacks, identifying source-indicating attributes, and identifying an audio-source. The training audio signals 203a include a diverse set of audio samples with varying acoustic characteristics having features indicative of whether a training audio signal 203a includes fraud and various source-indicating attributes. The training audio signals 203a may include bona fide or genuine audio samples and fraudulent audio samples.

The genuine audio samples are clean training audio signals 203a containing clear and identifiable speech audio, which may be verified or known to be originated from a trusted or verified source. The genuine samples include voiced-speech portions, where a speaker is clearly speaking, and unvoiced-speech portions, where the audio might contain background noise or silence without any speech. The training audio signals 203a may further include variance in the source-indicating attributes for genuine samples and fraudulent samples of the training audio signals 203a.

Input layers (not shown) of the machine-learning architecture include executable operations for ingesting input audio signals and performing various pre-processing and augmentation operations. Non-limiting examples of the pre-processing operations include extracting low-level input features from an input audio signal, parsing and segmenting the input audio signal into frames and segments, and performing one or more transformation functions, such as Short-time Fourier Transform (SFT) or Fast Fourier Transform (FFT), among other potential pre-processing operations. Non-limiting examples of augmentation operations include audio clipping, noise augmentation, frequency augmentation, duration augmentation, and the like.

The embedding extractors 204 are programmed and trained to extract certain features and fakeprint feature vector embeddings from the input audio signals 203 for the corresponding attribute detectors 206. An embedding extractor 204 includes the input layer of the machine-learning architecture 202, which ingests the input audio signal 203 and performs various pre-processing operations, such as segmentation, normalization, and transformation into a transform domain (e.g., spectro-temporal representation). The embedding extractor 204 may include a convolution neural network (CNN) or Recurrent Neural Network (RNN) trained to identify and extract certain features using the transform representation of the input audio signal 203. Each embedding extractor 204 extractor is trained to extract a set of low-level features relative to the particular attribute detector 206, to generate a feature vector embedding for the particular attribute detector 206.

The extracted feature vector embeddings from the embedding extractor 304a-304c are fed into the corresponding attribute detectors 306a-306c, which include machine-learning models programmed and trained classify or identify source-indicating attributes of the input audio signal 203. For instance, a first attribute detector 206a is programmed and trained for “input type” detection as a first source-indicating attribute. The first attribute detector 206a identifies whether the input audio was generated by text, synthetic speech, or genuine speech audio. A second attribute detector 206b is programmed and trained for acoustic model identification as a second source-indicating attribute. The second attribute detector 206b identifies or classifies the acoustic model used for generating the input audio signal 203. A third attribute detector 206c is programmed and trained for vocoder classification as a third source-indicating attribute. The third attribute detector 206c identifies or classifies the vocoder used for generating audio signal.

As an example, the first embedding extractor 204a extracts a first fakeprint vector from an input audio signal 203, and then feeds the fakeprint vector to the first attribute detector 206a to identify or classify the data input type used for generating the input audio signal 203 (as the first source-indicating attribute). For instance, the input type indicates whether the data input for generating the input audio signal 203 was text, speech, or genuine speech audio. As another example, the second embedding extractor 204b extracts a second fakeprint vector from the input audio signal 203, and then feeds the fakeprint vector to the second attribute detector 206b to identify or classify the acoustic model used for generating the input audio signal 203 (as the second source-indicating attribute). As another example, the third embedding extractor 204c extracts a third fakeprint vector from the input audio signal 203, and then feeds the fakeprint vector to the third attribute detector 206c to identify or classify the vocoder used for generating the input audio signal 203 (as the third source-indicating attribute).

The attribute detectors 206 include scoring layers and/or classifier layers that are programmed and trained to generate the attribute score. The scoring layer of the particular attribute detector 206 maps the refined embeddings to the respective classes for the source-indicating attribute being determined (e.g., acoustic model, vocoder, input type). The scoring layers of the attribute detector 206 include a softmax activation function that converts the raw source-attribute scores into probabilities for each class. The output values of each attribute detector 206 includes an attribute score between 0 and 1, and sum up to 1, representing a likelihood of each class for the given source-indicating attribute. In some cases, the source attribute outputs may include, for example, the source attribute score generated by fully-connect layers (or other scoring layers) of the attribute detectors 206. In some cases, the source attribute output of an attribute detector 206 may include, for example, a predicted source attribute generated by a classifier of the attribute detector 206.

The attribute detectors 206 may feed the source attribute outputs (e.g., source attribute score, source-attribute class) to a source tracer that includes a multi-class classifier 208. The multi-class classifier 208 is programmed and trained to identify or classify a particular originating source of the input audio signal 203 using the source attribute outputs from the respective attribute detectors 206. An output scoring layer provides the final classification results, indicating the predicted class for the attribute. For each attribute detector 206, the class with the highest probability is selected as the predicted source-indicating attribute. The machine-learning architecture 202 algorithmically combines or concatenates the source-indicated attribute scores and feeds the source-indicating attribute score to the multi-class classifier 208, which is programmed and trained to generate a signal source score to predict a particular audio source of the input audio signal 203.

During training, the machine-learning architecture 202 receives training audio signals 203a and training label data. Each embedding extractor 204 extracts a respective fakeprint embedding. Each attribute detector 206 uses a corresponding fakeprint embedding to generate a predicted source attribute output, which may include a predicted source attribute score or a predicted source attribute class. The multi-class classifier 208 then generates a predicted signal source score or predicted audio data source.

The machine-learning architecture 202 may execute one or more loss functions that generate a level of error or loss for each attribute detector 206. The loss function may compute the loss value for each particular attribute detectors 206 based upon a distance or comparison between one or more predicted source attribute outputs (e.g., predicted source attribute score, predicted source attribute class) as compared against one or more expected source attribute outputs (e.g., expected source attribute score, expected source attribute class) as indicated by the training label associated with the particular training audio signal 203a in the training dataset.

Additionally or alternatively, the machine-learning architecture 202 may execute a loss function that determines a loss for the multi-class classifier 208. The loss function determines the loss for the multi-class classifier 208 based upon a distance or comparison between one or more predicted signal source outputs (e.g., predicted source score, predicted signal source) as compared against one or more expected source outputs (e.g., expected source score, expected signal source) as indicated by the training label associated with the particular training audio signals 203a in the training dataset.

The loss function of the machine-learning architecture 202 may calculate the loss values that measures or indicates discrepancies between the predicted source attribute outputs and the expected source attribute outputs and/or between the predicted source output and the expected source output, using metrics such as cross-entropy loss for classification operations. Once the loss values are determined, the loss layers or other executable operations of the machine-learning architecture 202 employ backpropagation to adjust parameters or weights of the embedding extractors 204 and/or attribute detectors 206. As an example, during backpropagation, the machine-learning architecture 202 computes gradients of the loss function with respect to the parameters, and then updates the parameters to minimize the loss value or values for successive training iterations using successive input audio signal 203 samples. This iterative process continues until the machine-learning architecture 202 achieves an optimal performance, such that the machine-learning architecture 202 determines that the loss value or values satisfies corresponding training loss value threshold(s), effectively learning to discern source-indicating attributes indicative of originating sources of deepfakes and/or genuine audio signal data.

The training labels of a training audio signal 203a indicate expected outputs for the training audio signals 203a, such as an expected signal source score or expected signal source (for the multi-class classifier 208), expected feature vector embeddings (for the embedding extractors 204), and expected source attribute scores or expected source attribute classes (for the attribute detectors 206). The loss function determines the loss as the difference or discrepancy between the predicted outputs compared against the expected outputs. The server may compute a loss for the certain machine-learning models of the machine-learning architecture 202 and adjust the parameters of certain machine-learning models to train the machine-learning models separately. Additionally or alternatively, the server may compute the loss for multiple machine-learning models of the machine-learning architecture 202 and adjust and backpropagate adjustments to the parameters for multiple machine-learning models of the machine-learning architecture 202. In this way, the server may separately or jointly, train or tune the various machine-learning models of the machine-learning architecture 202. The server determines that the embedding extractors 204 and corresponding attribute detector 206 are trained when the loss satisfies a corresponding training threshold value. Additionally or alternatively, the server determines that the multi-class classifier 208 and machine-learning architecture 202 are trained when the loss of the outputs produced by the multi-class classifier 208 for the machine-learning architecture 202 satisfies a corresponding training threshold value.

The server may store and deploy a trained machine-learning architecture 202 that includes the trained embedding extractor 204, the trained attribute detectors 206, and the trained multi-class classifier 208.

At deployment, the server receives an inbound audio signals 203b and executes the machine-learning architecture 202. The machine-learning architecture 202 feeds the inbound audio signal 203b to the input layers to perform various preprocessing operations on the inbound audio signal 203b. The input layers feed the inbound audio signals 203b to the embedding extractors 204 to extract the respective feature vector embeddings. Each attribute detector 206 ingests the respective feature vector embeddings from the corresponding embedding extractors 204 and generates the source-indicating scores indicating the likely source-indicating attribute class. The machine-learning architecture 202 feeds the source-indicating scores to the multi-class classifier 208, which generates a signal source score indicating the likely signal source of the inbound audio signals 203b. The multi-class classifier 208 may generate the source signal score by algorithmically combining the source-attribute scores to generate or compute the signal source score. The multi-class classifier 208 may compare the signal source score against the thresholds values to identify or classify the signal source class or signal source identifier, which represents the likely source of the signal.

The server may generate and transmit a user interface for display at a user interface of a client computing device (e.g., admin devices 103, agent devices 116, end-user device 114), indicating a likely signal source that originated the inbound audio signals 203b, among other types of information.

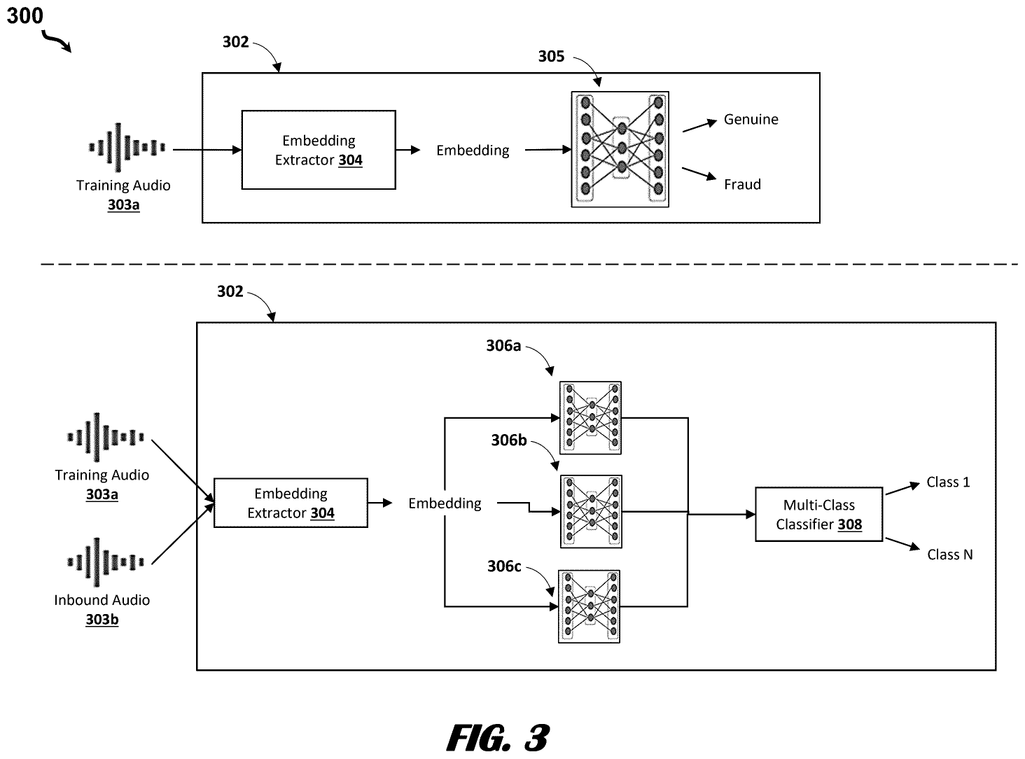

FIG. 3 shows data flow amongst components of a system 300 when training a machine-learning architecture 302 executed by a computer (e.g., analytics server 102) for deepfake detection and audio source tracing, according to an embodiment. The system 200 includes a server (e.g., analytics server 102) executing software programming and routines that implement a machine-learning architecture 302 for source tracing and deepfake detection. In the example system 300, the server executes the software programming of machine-learning layers of machine-learning models within the machine-learning architecture 302 for detecting deepfakes and source tracing for input audio signals 303a-303b (generally referred to as input audio signals 303) at various operational phases (e.g., training, deployment). For instance, at a training phase, the server executes the machine-learning architecture 302 using training audio signals 303a. At a deployment phase, the server executes the machine-learning architecture 302 using inbound audio signals 303b.

In the example embodiment of FIG. 3, the server implements a two-phase approach of training the machine-learning architecture 302 for audio source tracing using training audio data 303a, which the server obtains from one or more corpora of database (e.g., analytics database 104, provider databases 112) or other data source containing training audio data 303a. In a first phase, the server trains an embedding extractor 304 to extract fakeprint feature vector embeddings as a frontend using a deepfake detector 305 to generate a risk score and fraud classification as a backend to inform feedback and training of the embedding extractor 304. After training the embedding extractor 304 in the first phase, the server fixes the parameters of the embedding extractor 304 and moves to the second phase. In the second phase, the server uses a common fakeprint and trains attribute detectors 306a-306c (generally referred to as attribute detectors 306) for multi-class attribute classification by a multi-class classifier 308 of source-tracer.

The machine-learning architecture 302 includes an embedding extractor 304, a deepfake detector 305, attribute detectors 306a-306c (generally referred to as attribute detectors 306), and multi-class classifier 308. The embedding extractor 304 functions as the frontend for ingesting the training audio data 303a and extracting the fakeprints, among other potential functions. In the first phase, the deepfake detector 305 functions as the backend that identifies or classifies the training audio data 303 as genuine or fraudulent. In the second phase, the embedding extractor 304 functions as the frontend, and the attribute detectors 306 and the multi-class classifier 308 function as a backend that identifies or classifies certain source-indicating attributes (e.g., input type, acoustic model, vocoder), and identifies or classifies an audio source of the training audio data 303.

The server trains the machine-learning architecture 302 for audio source tracing using training audio signals 303a. The training audio signals 203a used for training the components of the machine-learning architecture 302 for detecting deepfake attacks, identifying source-indicating attributes, and identifying an audio-source. The training audio signals 203a include a diverse set of audio samples with varying acoustic characteristics having features indicative of whether a training audio signal 303a includes fraud and various source-indicating attributes. The training audio signals 303a may include bona fide or genuine audio samples and fraudulent audio samples.

The genuine audio samples are clean training audio signals 303a containing clear and identifiable speech audio, which may be verified or known to be originated from a trusted or verified source. The genuine samples include voiced-speech portions, where a speaker is clearly speaking, and unvoiced-speech portions, where the audio might contain background noise or silence without any speech. The training audio signals 303a may further include variance in the source-indicating attributes for genuine samples and fraudulent samples of the training audio signals 303a.

Input layers (not shown) of the machine-learning architecture include executable operations for ingesting input audio signals and performing various pre-processing and augmentation operations. Non-limiting examples of the pre-processing operations include extracting low-level input features from an input audio signal, parsing and segmenting the input audio signal into frames and segments, and performing one or more transformation functions, such as Short-time Fourier Transform (SFT) or Fast Fourier Transform (FFT), among other potential pre-processing operations. Non-limiting examples of augmentation operations include audio clipping, noise augmentation, frequency augmentation, duration augmentation, and the like.

The embedding extractor 304 is programmed and trained to extract certain features and fakeprint feature vector embeddings from the input audio signals 203. An embedding extractor 304 includes the input layer of the machine-learning architecture 302, which ingests the input audio signal 303 and performs various pre-processing operations, such as segmentation, normalization, and transformation into a transform domain (e.g., spectro-temporal representation). The embedding extractor 304 may include a convolution neural network (CNN) or Recurrent Neural Network (RNN) trained to identify and extract certain features using the transform representation of the input audio signal 303. The embedding extractor 304 is trained to extract a set of low-level features for a feature vector embedding, which the machine-learning architecture 302 feeds to the deepfake detector 305.

The deepfake detector 305 includes layers of one or more machine-learning models programmed and trained for extracting features of the input audio signals 303 and identifying instances of deepfakes occurring in the input audio signals 303. The deepfake detector 305 include scoring layers and/or classifier layers that are programmed and trained to generate the risk score and fraud determination using the fakeprint generated by the embedding extractor 304. The scoring layers generate the risk score based upon similarities between the fakeprint and previously trained or generated fraud-detection clusters or centroids. The machine-learning architecture 302 feeds the fakeprint to the fraud classifier or scoring layers to perform various scoring operations. The scoring layers and/or the fraud classifier perform a distance scoring operation that determines the distance (e.g., similarities, differences) between the fakeprint and a centroid or fakeprint feature vector previously generated as fraud-detection cluster using training fakeprints extracted for the training audio signals 303a. The risk score generated by the deepfake detector 305 indicates the likelihood that the input audio signal 303 is genuine or fraudulent. The risk score may be a value generated by the scoring layers and/or fraud classifier based on one or more scoring operations (e.g., distance scoring). For instance, the scoring layers or classifier of the deepfake detector 305 determines whether the distance score or other outputted values satisfy threshold values.

The embedding extractor 304 extracts the common fakeprint embedding for input audio signals 303. The machine-learning architecture 302 then feeds the fakeprint embedding to a first attribute detector 306a that is programmed and trained to identify or classify the “input type” used for generating the training audio data 303 (as a first source-indicating attribute). For instance, the input type indicates whether the input for generating the training audio data 303 was text, speech, or genuine speech audio. The machine-learning architecture 302 may also feed the fakeprint embedding to a second attribute detector 306b that is programmed and trained to identify or classify the “acoustic model” used for generating the training audio data 303 (as a second source-indicating attribute). The machine-learning architecture 302 may further feed the fakeprint embedding to a third attribute detector 306c that is programmed and trained to identify or classify the “vocoder” used for generating the training audio data 303 (as a third source-indicating attribute).

The attribute detectors 306 include machine-learning models programmed and trained classify or identify source-indicating attributes of the input audio signal 303. For instance, a first attribute detector 306a is programmed and trained for “input type” detection as a first source-indicating attribute. The first attribute detector 306a identifies whether the input audio was generated by text, synthetic speech, or genuine speech audio. A second attribute detector 306b is programmed and trained for acoustic model identification as a second source-indicating attribute. The second attribute detector 306b identifies or classifies the acoustic model used for generating the input audio signal 303. A third attribute detector 306c is programmed and trained for vocoder classification as a third source-indicating attribute. The third attribute detector 306c identifies or classifies the vocoder used for generating audio signal.

The attribute detectors 306 include scoring layers and/or classifier layers that are programmed and trained to generate the attribute score. The scoring layer of the particular attribute detector 306 maps the refined embedding to the respective classes for the source-indicating attribute being determined (e.g., acoustic model, vocoder, input type). The scoring layers of the attribute detector 306 include a softmax activation function that converts the raw source-attribute scores into probabilities for each class. The output values of each attribute detector 306 includes an attribute score between 0 and 1, and sum up to 1, representing a likelihood of each class for the given source-indicating attribute. In some cases, the source attribute outputs may include, for example, the source attribute score generated by fully-connect layers (or other scoring layers) of the attribute detectors 306. In some cases, the source attribute output of an attribute detector 306 may include, for example, a predicted source attribute generated by a classifier of the attribute detector 306.

The attribute detectors 306 may feed the source attribute outputs (e.g., source attribute score, source-attribute class) to a source tracer that includes a multi-class classifier 308. The multi-class classifier 308 is programmed and trained to identify or classify a particular originating source of the input audio signal 303 using the source attribute outputs from the respective attribute detectors 306. An output scoring layer provides the final classification results, indicating the predicted class for the attribute. For each attribute detector 306, the class with the highest probability is selected as the predicted source-indicating attribute.

The machine-learning architecture 302 algorithmically combines or concatenates the source-indicated attribute scores and feeds the source-indicating attribute score to the multi-class classifier 308, which is programmed and trained to generate a signal source score to predict a particular audio source of the input audio signal 303.

For the first training phase, the embedding extractor 304 extracts a fakeprint feature vector embedding from features of a training audio signal 303a and training label data. The machine-learning architecture 302 then feeds the fakeprint embedding to the deepfake detector 305 that is programmed and trained to identify or classify the training audio data 303 as genuine or fraud. For the training audio signal 303a, the deepfake detector 305 generates one or more predicted outputs, such as a predicted risk score indicating a likelihood that the training audio data 303a contains a deepfake or fraudulent audio data, or a predicted deepfake risk classification (e.g., genuine, fraudulent) indicating a determination of whether the training audio data 303a is genuine or fraudulent. The machine-learning architecture 302 may execute a loss function that generates a level of error or loss for the embedding extractor 304 and deepfake detector 305. The loss function may compute this loss value based upon a distance or comparison between the one or more predicted outputs (e.g., predicted fakeprint embedding, predicted risk score, predicted risk classification) as compared against one or more expected outputs (e.g., expected fakeprint embedding, expected risk score, expected risk classification) as indicated by the training label associated with the particular training audio data 303a in the training dataset.

The loss function of the machine-learning architecture 302 for the first phase may calculate the loss value as a measurement that indicates discrepancies between the predicted outputs and expected outputs, using metrics such as cross-entropy loss for classification operations. Once the loss value is determined, the loss layer or other executable operations of the machine-learning architecture 302 employs backpropagation to adjust parameters or weights of the embedding extractor 304 and/or deepfake detector 305. As an example, during backpropagation, the machine-learning architecture 302 computes gradients of the loss function with respect to the parameters of the embedding extractor 304 and/or deepfake detector 305 and then updates the parameters to minimize the loss value or values for successive training iterations using successive training audio signals 303a. This iterative process continues until the embedding extractor 304 and deepfake detector 305 achieve an optimal performance, such that the machine-learning architecture 302 determines that the loss value produced by the embedding extractor 304 and the deepfake detector 305 satisfies a corresponding first training loss value threshold. The machine-learning architecture 302 determines that the embedding extractor 304 and deepfake detector 305 are adequately trained when the loss value satisfies the first training threshold. The server disables the deepfake detector 305, fixes the parameters of the embedding extractor 304, and proceeds to the second training phase.

In the second training phase, the embedding extractor 304 extracts a common fakeprint feature vector embedding for a training audio data 303a. Each attribute detector 306 uses the common fakeprint embedding to generate a respective, predicted source attribute output (e.g., predicted source attribute score, predicted source attribute classe). The multi-class classifier 308 then generates one or more predicted signal source outputs (e.g., predicted signal source score, predicted signal source class).

The machine-learning architecture 302 may execute one or more loss functions that generate a level of error or loss for each attribute detector 306. The loss function may compute the loss value for each particular attribute detectors 306 based upon a distance or comparison between one or more predicted source attribute outputs (e.g., predicted source attribute score, predicted source attribute class) as compared against one or more expected source attribute outputs (e.g., expected source attribute score, expected source attribute class) as indicated by the training label associated with the particular training audio signal 303a in the training dataset.

Additionally or alternatively, the machine-learning architecture 302 may execute a loss function that determines a loss for the multi-class classifier 308. The loss function determines the loss for the multi-class classifier 308 based upon a distance or comparison between one or more predicted signal source outputs (e.g., predicted source score, predicted signal source) as compared against one or more expected source outputs (e.g., expected source score, expected signal source) as indicated by the training label associated with the particular training audio signals 303a in the training dataset.

The loss functions of the machine-learning architecture 302 for the second training phase may calculate the loss values as measurements that indicate discrepancies between the predicted source attribute outputs and the expected source attribute outputs and/or between the predicted source output and the expected source output, using metrics such as cross-entropy loss for classification operations. Once the loss values are determined, the loss layers or other executable operations of the machine-learning architecture 302 employ backpropagation to adjust parameters or weights of the attribute detectors 306. As an example, during backpropagation, the machine-learning architecture 302 computes gradients of the loss function with respect to the parameters of the attribute detectors 306 or multi-class classifier 308 and then updates the parameters of the attribute detectors 306 or multi-class classifier 308 to minimize the loss value or values for successive training iterations using successive training audio data 303 samples. Optionally, in some implementations, the loss layers in the second training phase may fine-tune or adjust the parameters of the embedding extractor 304, though the parameters of the embedding extractor 304 may remain fixed. This iterative process continues until the attribute detectors 306 or multi-class classifier 308 of the machine-learning architecture 302 achieve an optimal performance, such that the machine-learning architecture 302 determines that the loss value or values satisfies corresponding training loss value threshold(s).

The training labels of a training audio signal 303a indicate expected outputs for the training audio signals 303a, such as an expected signal source score or expected signal source (for the multi-class classifier 308), expected feature vector embeddings (for the embedding extractors 304), and expected source attribute scores or expected source attribute classes (for the attribute detectors 306). The loss function determines the loss as the difference or discrepancy between the predicted outputs compared against the expected outputs. The server may compute a loss for the certain machine-learning models of the machine-learning architecture 302 and adjust the parameters of certain machine-learning models to train the machine-learning models separately. The server determines that the attribute detectors 306 and/or multi-class classifier 308 are trained when the loss satisfies a corresponding training threshold value.

The server may store and deploy the trained embedding extractor 304 and the trained deepfake detector 305 for detecting instances of fraud in deepfake audio signals. The server may also store and deploy the trained machine-learning architecture 302 that includes the trained embedding extractor 304, the trained attribute detectors 306, and the trained multi-class classifier 308.

At deployment, the server receives an inbound audio signals 303b and executes the machine-learning architecture 302. The machine-learning architecture 302 feeds the inbound audio signal 303b to the input layers to perform various preprocessing operations on the inbound audio signal 303b. The input layers feed the inbound audio signals 303b to the embedding extractor 304 to extract the common feature vector embedding. Each attribute detector 306 ingests the feature vector embedding from the embedding extractor 304 and generates the source-attribute scores indicating the likely source-attributes. The machine-learning architecture 302 feeds the source-attributes scores to the multi-class classifier 308, which generates a signal source score indicating the likely signal source of the inbound audio signals 303b. The multi-class classifier 308 may generate the source signal score by algorithmically combining the source-attribute scores to generate or compute the signal source score. The multi-class classifier 308 may compare the signal source score against the thresholds values to identify or classify the signal source class or signal source identifier, which represents the likely source of the signal.

The server may generate and transmit a user interface for display at a user interface of a client computing device (e.g., admin devices 103, agent devices 116, end-user device 114), indicating a likely signal source that originated the inbound audio signals 203b, among other types of information.

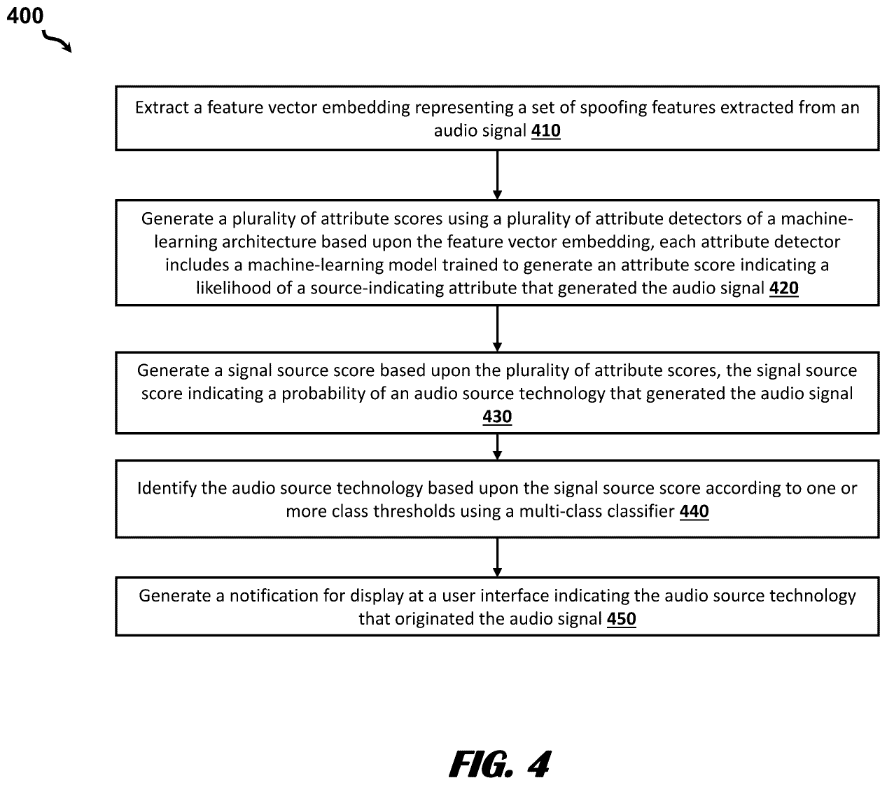

FIG. 4 is a flowchart showing operations of a computer-implemented method 400 for detecting fraudulent calls and source detection using a machine-learning architecture, according to an embodiment.

At operation 410, a computer (e.g., analytics server 102 of FIG. 1, server of FIGS. 2-3) extracts a feature vector embedding representing a set of spoofing features that the computer has extracted from a transformation domain representation of an input audio signal.

At operation 420, the computer generates a plurality of attribute scores using a plurality of attribute detectors of a machine-learning architecture based upon the feature vector embedding. Each attribute detector includes a machine-learning model trained to generate an attribute score indicating a likelihood of a source-indicating attribute generated the input audio signal. The computer compares the attribute scores against one or more source attribute classification threshold scores of the multi-class classifiers of the attribute detectors.

At operation 430, the computer generates a signal source score based upon the plurality of attribute scores. The signal source score indicates a probability of an audio source technology generated the input audio signal.

At operation 440, the computer identifies the audio source technology that generated the input audio signal based upon the signal source score according to one or more class thresholds using a multi-class classifier. The computer compares the source score against one or more source classification threshold scores of the multi-class classifier. At operation 450, the computer generates a notification for display at a user interface indicating the audio source technology that originated the audio signal.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for detecting fraudulent calls and source detection using machine-learning, the method comprising:
extracting, by a computer, a feature vector embedding representing a set of spoofing features extracted from an input audio signal;
generating, by the computer, a plurality of attribute scores using a plurality of attribute detectors of a machine-learning architecture based upon the feature vector embedding, each attribute detector includes a machine-learning model trained to generate an attribute score indicating a likelihood of a source-indicating attribute that generated the audio signal;
generating, by the computer, a signal source score based upon the plurality of attribute scores, the signal source score indicating a probability of an audio source technology that generated the audio signal;
identifying, by the computer, the audio source technology based upon the signal source score according to one or more class thresholds using a multi-class classifier; and
generating, by the computer, a notification for display at a user interface indicating the audio source technology that originated the audio signal.

2. The method according to claim 1, wherein the source-indicating attribute includes at least one of an input type, an acoustic model, or a vocoder.

3. The method according to claim 1, further comprising training, by the computer, a first embedding extractor to extract the feature vector embedding having the spoofing features using a plurality of training audio signals including the audio signal and corresponding training labels.

4. The method according to claim 1, further comprising training, by the computer, a plurality of embedding extractors for extracting a plurality of feature vector embeddings corresponding to the plurality of attribute detectors, including the first embedding extractor corresponding to a first attribute detector, and a second embedding extractor corresponding to the a second attribute detector.

5. The method according to claim 1, further comprising generating, by the computer, a first attribute score for a first source-indicating attribute using a first attribute detector based upon the feature vector embedding.

6. The method according to claim 5, further comprising:
extracting, by the computer, a second feature vector embedding representing a second set of spoofing features extracted from the audio signal; and
generating, by the computer, a second attribute score for a second source-indicating attribute based upon the second feature vector embedding using a second attribute detector.

7. The method according to claim 1, further comprising generating, by the computer, a loss for the signal source score using a loss function, the loss indicating a distance between the signal source and an expected signal source score indicated by a training label associated with the input audio signal.

8. The method according to claim 7, further comprising updating, by the computer, one or more parameters of the multi-class classifier model based upon the loss.

9. The method according to claim 7, further comprising updating, by the computer, one or more parameters of one or more embedding extractors model based upon the loss.

10. The method according to claim 7, further comprising updating, by the computer, one or more parameters of one or more source attribute detectors based upon the loss.

11. A system for detecting fraudulent calls and source detection using machine-learning, the system comprising:
a computer comprising at least one processor, the computer configured to:
extract a feature vector embedding representing a set of spoofing features extracted from the audio signal;
generate a plurality of attribute scores using a plurality of attribute detectors of a machine-learning architecture based upon the feature vector embedding, each attribute detector includes a machine-learning model trained to generate an attribute score indicating a likelihood of a source-indicating attribute that generated the audio signal;
generate a signal source score based upon the plurality of attribute scores, the signal source score indicating a probability of an audio source technology that generated the audio signal;
identify the audio source technology based upon the signal source score according to one or more class thresholds using a multi-class classifier; and
generate a notification for display at a user interface indicating the audio source technology that originated the audio signal.

12. The system according to claim 11, wherein the source-indicating attribute includes at least one of an input type, an acoustic model, or a vocoder.

13. The system according to claim 11, wherein the computer is further configured to train a first embedding extractor to extract the feature vector embedding having the spoofing features using a plurality of training audio signals including the audio signal and corresponding training labels.

14. The system according to claim 11, wherein the computer is further configured to train a plurality of embedding extractors for extracting a plurality of feature vector embeddings corresponding to the plurality of attribute detectors, including the first embedding extractor corresponding to a first attribute detector, and a second embedding extractor corresponding to a second attribute detector.

15. The system according to claim 11, wherein the computer is further configured to generate a first attribute score for a first source-indicating attribute using a first attribute detector based upon the feature vector embedding.

16. The system according to claim 15, wherein the computer is further configured to:
extract a second feature vector embedding representing a second set of spoofing features extracted from the audio signal; and
generate a second attribute score for a second source-indicating attribute based upon the second feature vector embedding using a second attribute detector.

17. The system according to claim 11, wherein the computer is further configured to generate a loss for the signal source score using a loss function, the loss indicating a distance between the signal source and an expected signal source score indicated by a training label associated with the input audio signal.

18. The system according to claim 17, wherein the computer is further configured to update one or more parameters of the multi-class classifier model based upon the loss.

19. The system according to claim 17, wherein the computer is further configured to update one or more parameters of one or more embedding extractors model based upon the loss.

20. The system according to claim 17, wherein the computer is further configured to update one or more parameters of one or more source attribute detectors based upon the loss.
